(19) United States
(12) Patent Application Publication
(10) Pub. No.: US 2012/0185335 A1
(43) Pub. Date: Jul. 19, 2012

(54) DIFFERENTIATED DISPLAY OF ADVERTISEMENTS BASED ON DIFFERENTIATING CRITERIA

(75) Inventor: Georgios Tsirtsis, London (GB)

(73) Assignee: QUALCOMM Incorporated, San Diego, CA (US)

(21) Appl. No.: 13/008,236

(22) Filed: Jan. 18, 2011

(51) Int. Cl. G06Q 30/00

(52) U.S. Cl. 705/14.64

(57) ABSTRACT

A method of operating a wireless device includes displaying an advertisement on the wireless device. In addition, the method includes differentiating the display of the advertisement based on at least one criterion in order to indicate to a user of the wireless device a satisfaction of the at least one criterion. A method of operating a server includes receiving at least one criterion. In addition, the method includes differentiating a display of an advertisement based on the at least one criterion in order to indicate to a user of a wireless device a satisfaction of the at least one criterion. Furthermore, the method includes sending the differentiated advertisement for display on the wireless device.

### BACKGROUND

1. Field

The present disclosure relates generally to communication systems, and more particularly, to differentiated display of advertisements based on differentiating criteria.

2. Background

Advertisements may be delivered to a user based on context. The context may be based on semi-static criteria, such as user demographics, or dynamic criteria, such as information entered into a search request. As such, advertisements may be tailored to a user based on context. There is a current need in the art to differentiate such advertisements in order to provide information to users in relation to the advertisements.

### SUMMARY

In an aspect of the disclosure, a method of operating a wireless device is provided in which an advertisement is displayed on the wireless device. In addition, the display of the advertisement is differentiated based on at least one criterion in order to indicate to a user of the wireless device a satisfaction of the at least one criterion.

In an aspect of the disclosure, a method of operating a server is provided in which at least one criterion is received. In addition, a display of an advertisement is differentiated based on the at least one criterion in order to indicate to a user of a wireless device a satisfaction of the at least one criterion. Furthermore, the differentiated advertisement is sent for display on the wireless device.

### BRIEF DESCRIPTION OF THE DRAWINGS

FIG. 1 is a diagram illustrating an example of a hardware implementation for an apparatus employing a processing system.

FIG. 2 is a drawing of a wireless peer-to-peer communications system.

FIG. 3 is a diagram for illustrating an exemplary method.

FIG. 4 is a flow chart of a first method of an exemplary wireless device.

FIG. 5 is a flow chart of a second method of an exemplary wireless device.

FIG. 6 is a flow chart of a third method of an exemplary wireless device.

FIG. 7A is a flow chart of a fourth method of an exemplary wireless device.

FIG. 7B is a flow chart of a fifth method of an exemplary wireless device.

FIG. 8 is a flow chart of a first method of an exemplary server.

FIG. 9 is a flow chart of a second method of an exemplary server.

FIG. 10 is a conceptual block diagram illustrating the functionality of an exemplary wireless device.

FIG. 11 is a conceptual block diagram illustrating the functionality of an exemplary server.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of communication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

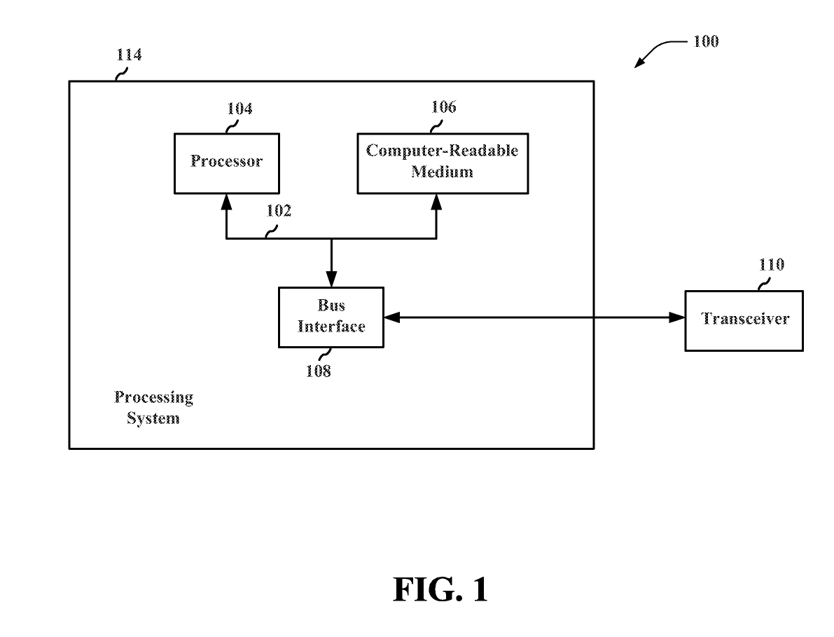

FIG. 1 is a conceptual diagram illustrating an example of a hardware implementation for an apparatus 100 employing a processing system 114. The processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatuses over a transmission medium.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

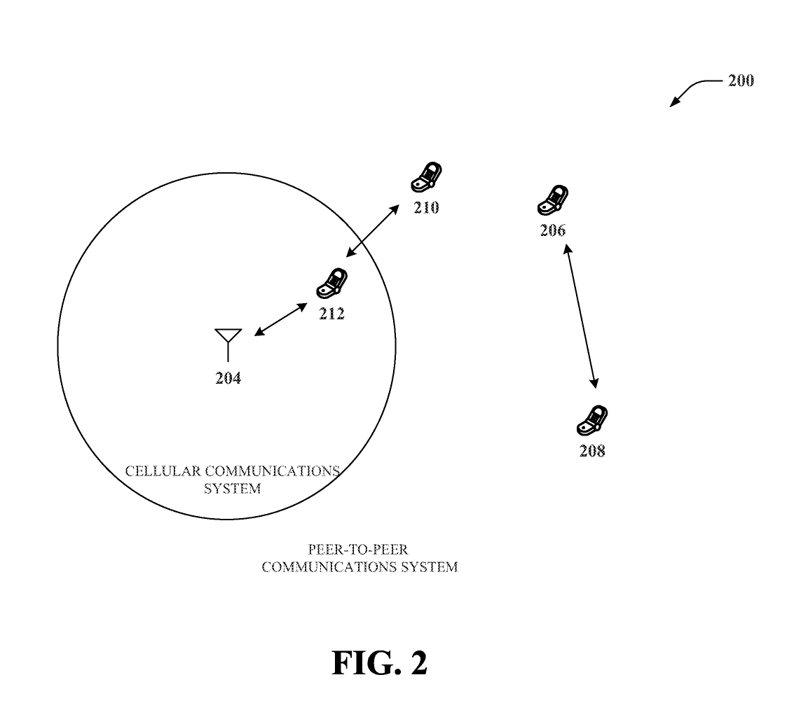

FIG. 2 is a drawing of an exemplary peer-to-peer communications system 200. The peer-to-peer communications system 200 includes a plurality of wireless devices 206, 208, 210, 212. The peer-to-peer communications system 200 may overlap with a cellular communications system, such as for example, a wireless wide area network (WWAN). Some of the wireless devices 206, 208, 210, 212 may communicate together in peer-to-peer communication, some may communicate with the base station 204, and some may do both. For example, as shown in FIG. 2, the wireless devices 206, 208 are in peer-to-peer communication and the wireless devices 210, 212 are in peer-to-peer communication. The wireless device 212 is also communicating with the base station 204.

The wireless device may alternatively be referred to by those skilled in the art as user equipment, a mobile station, a subscriber station, a mobile unit, a subscriber unit, a wireless unit, a wireless node, a remote unit, a mobile device, a wireless communication device, a remote device, a mobile subscriber station, an access terminal, a mobile terminal, a wireless terminal, a remote terminal, a handset, a user agent, a mobile client, a client, or some other suitable terminology. The base station may alternatively be referred to by those skilled in the art as an access point, a base transceiver station, a radio base station, a radio transceiver, a transceiver function, a basic service set (BSS), an extended service set (ESS), a Node B, an evolved Node B, or some other suitable terminology.

The exemplary methods and apparatuses discussed infra are applicable to any of a variety of wireless peer-to-peer communications systems, such as for example, a wireless peer-to-peer communication system based on FlashLinQ, WiMedia, Bluetooth, ZigBee, or Wi-Fi based on the IEEE 802.11 standard. To simplify the discussion, the exemplary methods and apparatus are discussed within the context of FlashLinQ. However, one of ordinary skill in the art would understand that the exemplary methods and apparatuses are applicable more generally to a variety of other wireless peer-to-peer communication systems.

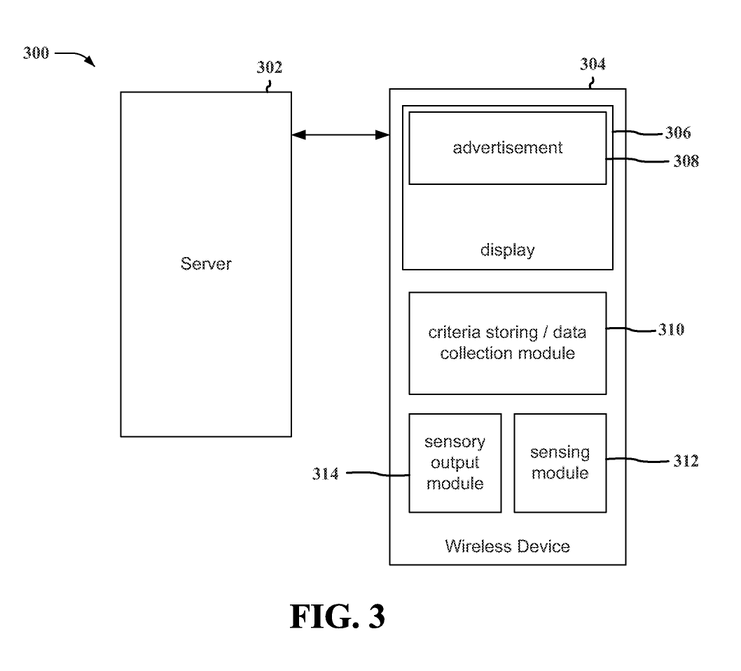

FIG. 3 is a diagram 300 for illustrating an exemplary method. As shown in FIG. 3, a wireless device 304 is in wireless communication with a server 302. The wireless device 304 has a display 306 for displaying graphical text/images to a user. According to the exemplary method, the wireless device 304 receives an advertisement 308 from the server 302 and displays the advertisement 308 differentiated based on one or more criteria in order to indicate to the user a satisfaction of the one or more criteria. The wireless device 302 may differentiate an advertisement 308 by displaying the advertisement with a particular banner, frame, background, color, font, text, and/or additional image when the one or more criteria are satisfied. The one or more criteria include demographics, a location associated with the advertisement, a proximity of the wireless device 304 to the location associated with the advertisement (i.e., how close the wireless device 304 is to the location associated with the advertisement), and/or other criteria through which groups of users can be categorized. For example, additional criteria through which advertisements may be differentiated may include direction of travel, velocity, altitude, humidity, temperature, noise, light intensity, orientation, or other criteria that may be measured and/or determined by the wireless device 304. The demographics include sex, gender, race, age, income, disabilities, mobility (in terms of travel time to work or number of vehicles available), educational attainment, home ownership, employment status, and/or other demographical information through which groups of users can be categorized.

The wireless device 304 includes a criteria storing/data collection module 310 for collecting data/criteria (e.g., demographical information) through which the advertisement may be differentiated. The wireless device 304 further includes a sensing module 312 for sensing environmental conditions through which the advertisement may be differentiated. The environmental conditions include GPS location, proximity, direction of travel, velocity, altitude, humidity, temperature, noise, light intensity, orientation, and/or other criteria that may be measured or determined by the wireless device 304. The wireless device 304 may further include a sensory output module 314 for differentiating the advertisement through other sensory outputs other than a visual differentiation. For example, the sensory output module 314 may differentiate the advertisement audibly (through sound) or through the sense of touch with actuator movement (e.g., vibration), surface texture changes, temperature changes, or other means of providing a signal to a user though the user's sense of touch.

Examples best demonstrate the exemplary method. In one example, the wireless device 304 may display advertisements from stores within a certain distance (determined by an absolute value, e.g., ¼ of a mile, or a power level of a signal, e.g., a FlashLinQ discovery signal, a Bluetooth signal, etc.) of the wireless device 304 with a different background color to indicate that the wireless device 304 is proximate to potential items of interest. In another example, the wireless device 304 may display an advertisement with a red dot above the advertisement when the advertisement is directed to women between the ages of 23 and 32, or when the target demographic of the advertisement (say women between ages of 23 and 32) match the demographic of the device's user. In yet another example, the wireless device 304 may display an advertisement with an identifier such as an arrow indicating a direction of the location associated with the advertisement with respect to the current location and orientation of the wireless device 304.

The server 302 may send data with the advertisement through which the wireless device 304 may differentiate the advertisement. For example, the advertisement may include demographic targets, a location, and/or other information through which the wireless device 304 may differentiate the advertisement. As discussed supra, rather than differentiate visually, the wireless device 304 may differentiate audibly through playing different sounds/music when the advertisement is received and/or viewed or may differentiate physically through actuator movement within the wireless device 304. Alternatively, the wireless device 304 may differentiate through other means sensed through touch, such as providing different perceived tactile surfaces to a user in order to indicate a satisfaction of the one or more criteria in association with an advertisement.

The one or more criteria may be user controlled. As such, a user may be able to configure the wireless device 304 to display advertisements differentiated based on the one or more criteria in order to indicate to the user a satisfaction of the one or more criteria. For example, a user may be able to configure the wireless device 304 to display advertisements that are directed to users who are 38 and from stores within ⅕ of a mile of the wireless device 304 with a blue frame and all other advertisements not meeting that criteria with a black frame.

When the one or more criteria include a location associated with the advertisement, the location may be determined through peer-to-peer wireless peer discovery or location information received with the advertisement. For example, the wireless device 304 may receive a peer discovery signal sent from a location associated with the advertisement and the wireless device may determine a proximity of the wireless device to the location associated with the advertisement through a power measurement of the received peer discovery signal. For another example, the wireless device 304 may receive location information embedded with the advertisement and may determine the location associated with the advertisement based on the received location information. The wireless device 304 may then determine its location and then determine a proximity of the wireless device 304 to the location associated with the advertisements based on a difference between the determined locations.

The wireless device 304 may not itself differentiate the advertisement, but rather, may display an advertisement differentiated by the server 302. That is, the wireless device 304 may send the one or more criteria to the server 302, receive the advertisement from the server 302 differentiated based on the one or more criteria, and display the differentiated advertisement. The wireless device 304 may send the one or more criteria to the server 302 through peer-to-peer communication. When the one or more criteria include a proximity of the wireless device 304 to the location associated with the advertisement, the server 302 may determine the respective locations of the wireless device 304 and the location associated with the advertisement, and differentiate the advertisement based on the determination that the wireless device 304 is proximate to the location associated with the advertisement.

The wireless device 304 may not determine whether the one or more criteria are satisfied, but rather, may receive information from the server 302 on which of the one or more criteria are satisfied. In such a configuration, the wireless device 304 sends the server 302 the one or more criteria, and the server 302 determines the one or more criteria that are satisfied and sends the advertisement along with information indicating the one or more criteria that are satisfied. In such a configuration, the wireless device 304 determines how to differentiate the advertisement based on the received information from the server 302. For example, assume the wireless device 304 has stored criteria for differentiating the advertisement that includes an age range of 23 to 32, a proximity of ⅓ of a mile, and a gender of female. The server 302 determines that the user is within ¼ of a mile from the location associated with the advertisement and that the advertisement is directed toward females, however the target age range of the advertisement is 40 to 50. The server 302 sends information to the wireless device 304 indicating that the proximity and gender criteria are satisfied. The wireless device 304 receives the information from the server 302 and determines whether to differentiate the advertisement based on the fact that only two of the three criteria are satisfied. In such a configuration, users may be able to set an importance or weight scale of each of the criteria and the wireless device 304 may be able to ascertain whether to differentiate the advertisement when some of the criteria are unsatisfied based on the importance or weight scale of each of the criteria.

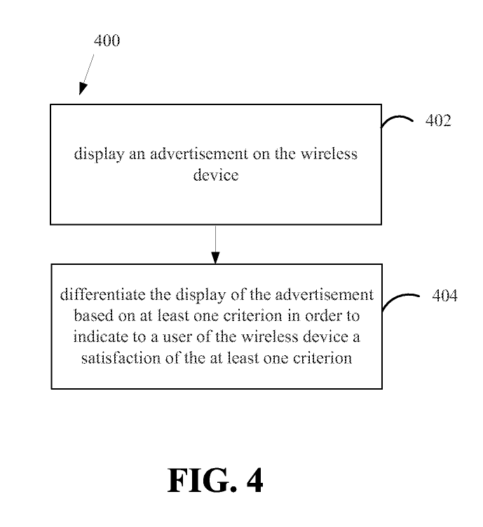

FIG. 4 is a flow chart 400 of a first method of an exemplary wireless device 304. As shown in FIG. 4, the wireless device 304 displays an advertisement on the wireless device 304 (402). In addition, the wireless device 304 differentiates the display of the advertisement based on at least one criterion in order to indicate to a user of the wireless device 304 a satisfaction of the at least one criterion (404). The at least one criterion may include at least one of a location associated with the advertisement or a proximity of the wireless device 304 to the location associated with the advertisement. The location associated with the advertisement may be determined through one of peer-to-peer wireless peer discovery or location information received with the advertisement. The at least one criterion may include demographics. To differentiate the display of the advertisement, the wireless device 304 may display the advertisement with a particular banner, frame, background color, font, or additional image when the at least one criterion is satisfied. The at least one criterion may be user controlled.

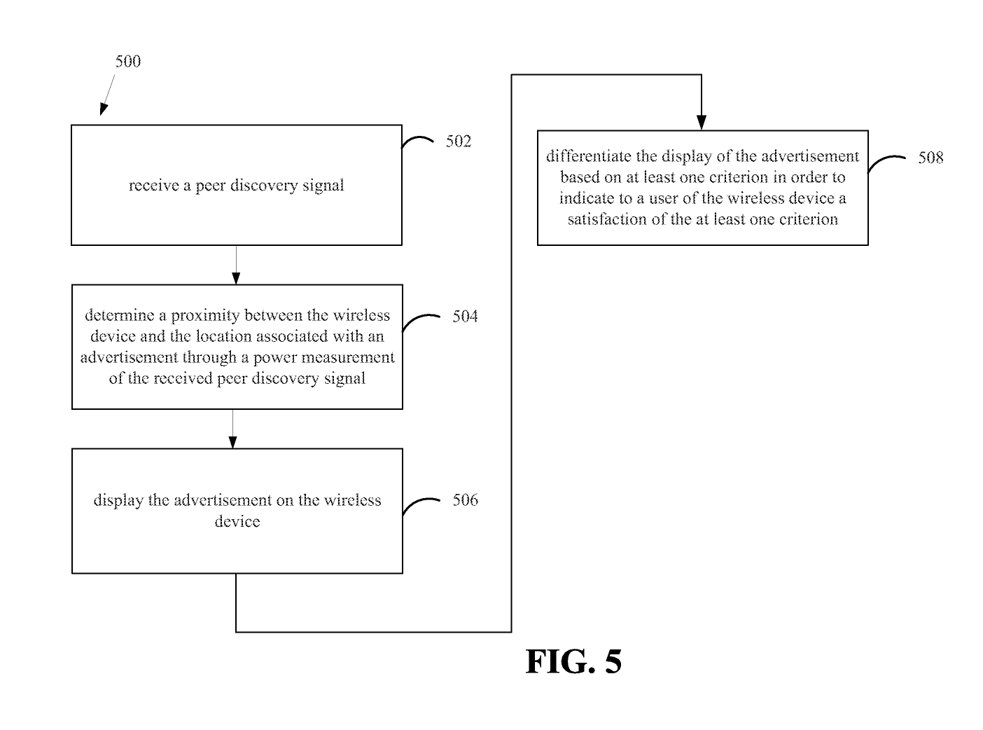

FIG. 5 is a flow chart 500 of a second method of an exemplary wireless device 304. As shown in FIG. 5, the wireless device 304 receives a peer discovery signal (502). The wireless device 304 determines a proximity of the wireless device 304 to the location associated with an advertisement through a power measurement of the received peer discovery signal (504). The wireless device 304 displays the advertisement on the wireless device 304 (506). The wireless device 304 differentiates the display of the advertisement based on at least one criterion in order to indicate to a user of the wireless device 304 a satisfaction of the at least one criterion (508).

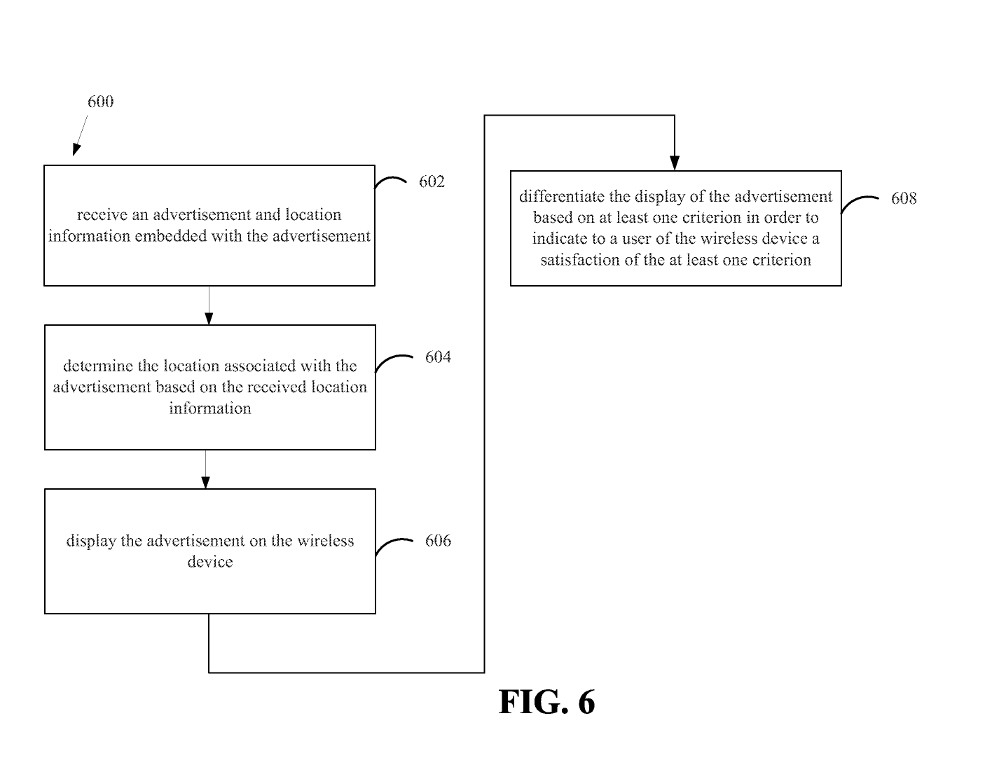

FIG. 6 is a flow chart 600 of a third method of an exemplary wireless device 304. As shown in FIG. 6, the wireless device 302 receives an advertisement and location information embedded with the advertisement (602). The wireless device 302 determines the location associated with the advertisement based on the received location information (604). The wireless device 304 displays the advertisement on the wireless device 304 (606). The wireless device 304 differentiates the display of the advertisement based on at least one criterion in order to indicate to a user of the wireless device 304 a satisfaction of the at least one criterion (608). In one configuration, the wireless device 304 determines a location of the wireless device 304 and determines the proximity of the wireless device 304 to the location associated with the advertisements based on a difference between the determined locations.

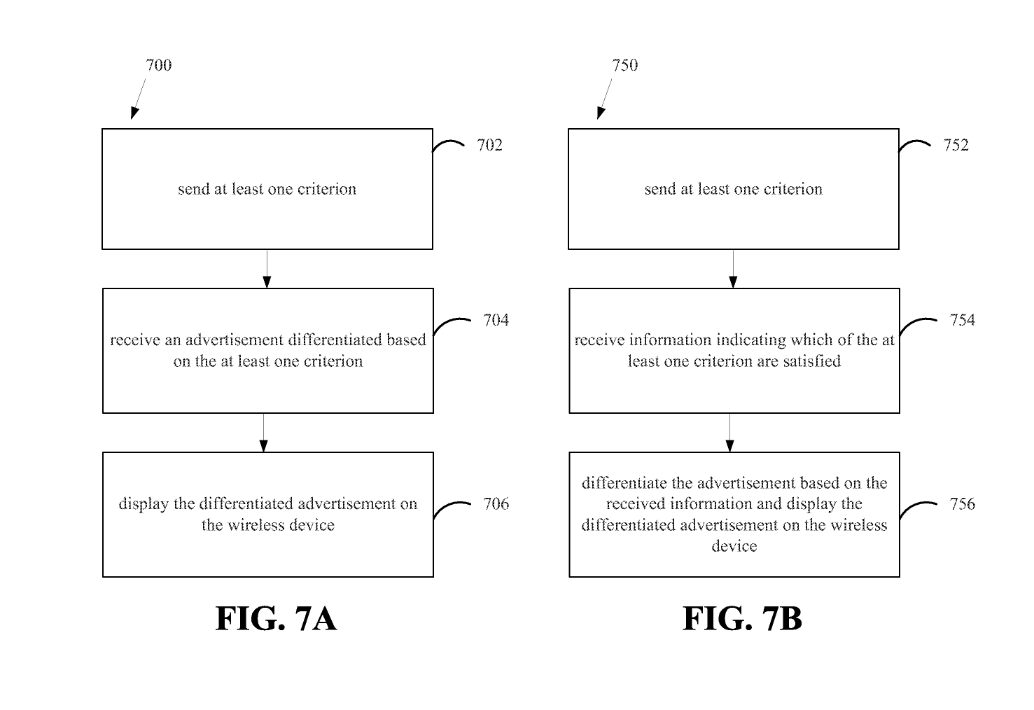

FIG. 7A is a flow chart 700 of a fourth method of an exemplary wireless device 304. As shown in FIG. 7A, the wireless device 304 sends the at least one criterion to the server 302 (702). The wireless device 304 receives an advertisement from the server 302 differentiated based on the at least one criterion (704). The wireless device 304 displays the differentiated advertisement on the wireless device 304 (706).

FIG. 7B is a flow chart 750 of a fifth method of an exemplary wireless device 304. As shown in FIG. 7B, the wireless device 304 sends the at least one criterion to the server 302 (752). The wireless device 304 receives information indicating which of the at least one criterion are satisfied (704). The wireless device 304 differentiates the advertisement based on the received information and displays the differentiated advertisement on the wireless device 304 (706).

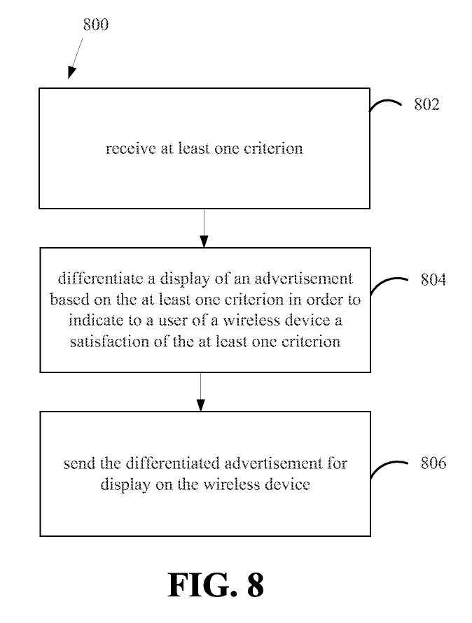

FIG. 8 is a flow chart 800 of a first method of an exemplary server 302. As shown in FIG. 8, the server 302 receives at least one criterion (802). In addition, the server 302 differentiates a display of an advertisement based on the at least one criterion in order to indicate to a user of a wireless device 304 a satisfaction of the at least one criterion (804). Furthermore, the server 302 sends the differentiated advertisement for display on the wireless device 304 (806). The at least one criterion may be received through peer-to-peer communication. The at least one criterion may include at least one of a location associated with the advertisement or a proximity of the wireless device 304 to the location associated with the advertisement. The at least one criterion may include demographics. The advertisement may be differentiated by a particular banner, frame, background color, font, or additional image in order to indicate to the user of the wireless device 304 the satisfaction of the at least one criterion.

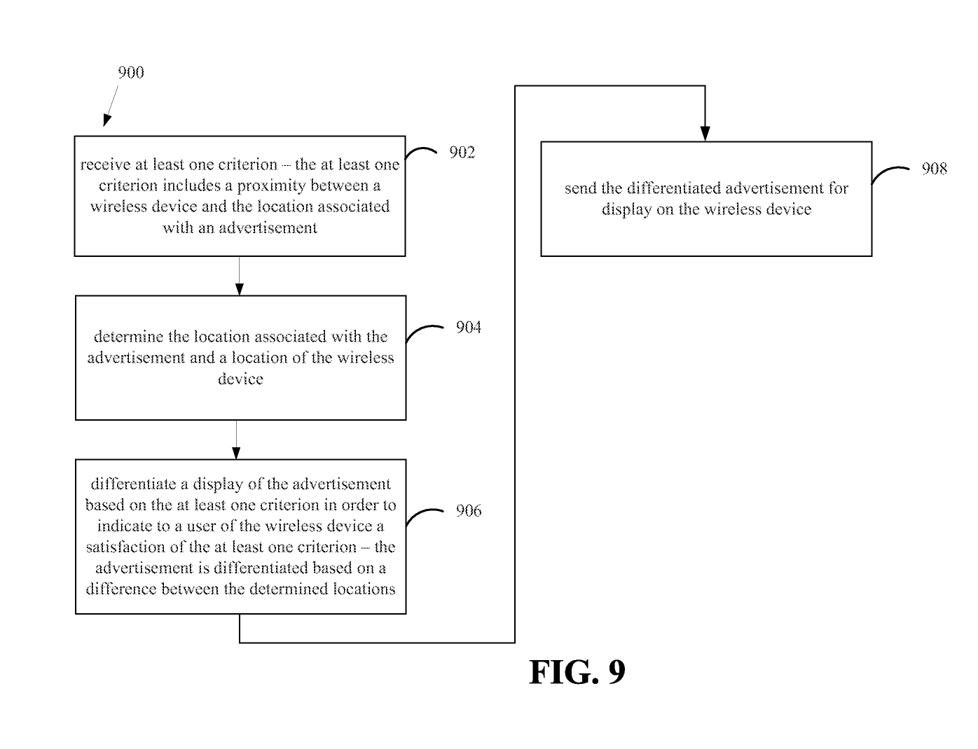

FIG. 9 is a flow chart 900 of a second method of an exemplary server. As shown in FIG. 9, the server 302 receives at least one criterion that includes a proximity of the wireless device 304 to the location associated with the advertisement (902). The server 302 determines the location associated with the advertisement and a location of the wireless device 304 (904). The server 302 differentiates a display of an advertisement based on the at least one criterion in order to indicate to a user of a wireless device 304 a satisfaction of the at least one criterion (906). As such, the advertisement is differentiated based on a difference between the determined locations. The server 302 sends the differentiated advertisement for display on the wireless device 304 (908).

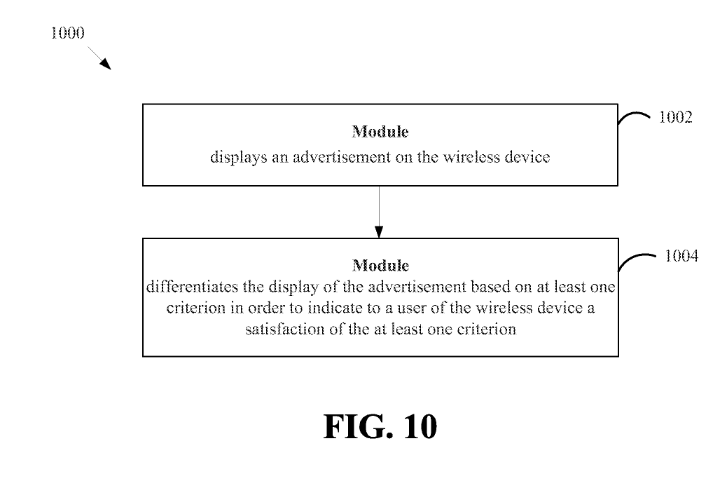

FIG. 10 is a conceptual block diagram 1000 illustrating the functionality of an exemplary wireless device 304. The wireless device 304 includes a module 1002 that displays an advertisement on the wireless device 304. In addition, the wireless device 304 includes a module 1004 that differentiates the display of the advertisement based on at least one criterion in order to indicate to a user of the wireless device 304 a satisfaction of the at least one criterion.

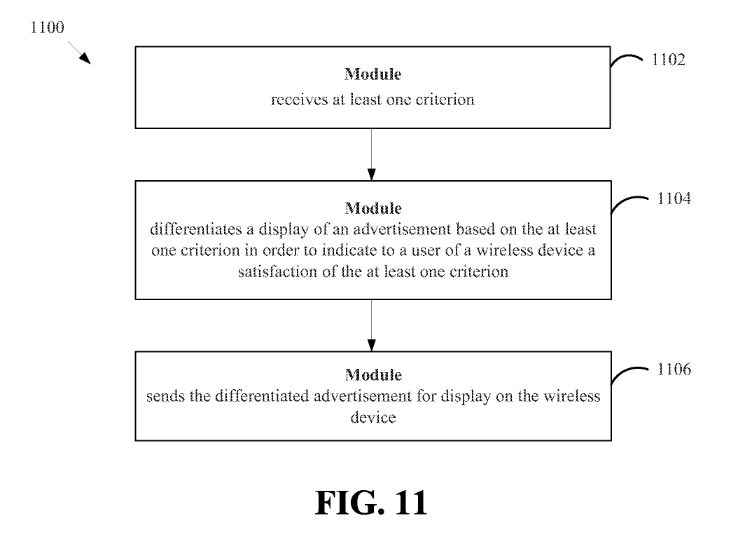

FIG. 11 is a conceptual block diagram 1100 illustrating the functionality of an exemplary server 302. The server 302 includes a module 1102 that receives at least one criterion. In addition, the server 302 includes a module 1104 that differentiates a display of an advertisement based on the at least one criterion in order to indicate to a user of a wireless device 304 a satisfaction of the at least one criterion. Furthermore, the server 302 includes a module 1106 that sends the differentiated advertisement for display on the wireless device 304.

Referring to FIG. 1, in one configuration, the apparatus 100 for wireless communication is a wireless device 304 and includes means for displaying an advertisement on the apparatus 100. In addition, the apparatus 100 includes means for differentiating the display of the advertisement based on at least one criterion in order to indicate to a user of the apparatus 100 a satisfaction of the at least one criterion. The apparatus 100 may further include means for receiving a peer discovery signal, and means for determining a proximity of the apparatus 100 to the location associated with the advertisement through a power measurement of the received peer discovery signal. The apparatus 100 may further include means for receiving the advertisement, means for receiving with the advertisement location information embedded with the advertisement, and means for determining the location associated with the advertisement based on the received location information. The apparatus 100 may further include means for determining a location of the apparatus 100, and means for determining the proximity of the apparatus 100 to the location associated with the advertisements based on a difference between the determined locations. The apparatus 100 may further include means for sending the at least one criterion, and means for receiving the advertisement differentiated based on the at least one criterion. In such a configuration, the means for differentiating displays the differentiated advertisement. The aforementioned means is the processing system 114 configured to perform the functions recited by the aforementioned means.

In another configuration, the apparatus 100 for wireless communication is a server 302 and includes means for receiving at least one criterion, means for differentiating a display of an advertisement based on the at least one criterion in order to indicate to a user of a second apparatus a satisfaction of the at least one criterion, and means for sending the differentiated advertisement for display on the second apparatus. The apparatus 100 may further include means for determining the location associated with the advertisement and a location of the second apparatus. In such a configuration, the at least one criterion includes the proximity of the second apparatus to the location associated with the advertisement, and the advertisement is differentiated based on a difference between the determined locations. The aforementioned means is the processing system 114 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of operating a wireless device, comprising:
displaying an advertisement on the wireless device; and
differentiating the display of the advertisement based on at least one criterion in order to indicate to a user of the wireless device a satisfaction of the at least one criterion.

2. The method of claim 1, wherein the at least one criterion includes at least one of a location associated with the advertisement or a proximity of the wireless device to the location associated with the advertisement.

3. The method of claim 1, wherein the location associated with the advertisement is determined through one of peer-to-peer wireless peer discovery or location information received with the advertisement.

4. The method of claim 3, further comprising:
receiving a peer discovery signal; and
determining a proximity of the wireless device to the location associated with the advertisement through a power measurement of the received peer discovery signal.

5. The method of claim 3, further comprising:
receiving the advertisement;
receiving with the advertisement location information embedded with the advertisement; and
determining the location associated with the advertisement based on the received location information.

6. The method of claim 5, further comprising:
determining a location of the wireless device; and
determining the proximity of the wireless device to the location associated with the advertisements based on a difference between the determined locations.

7. The method of claim 1, further comprising:
sending the at least one criterion; and
receiving the advertisement differentiated based on the at least one criterion,
wherein the differentiating comprises displaying the differentiated advertisement.

8. The method of claim 1, further comprising:
sending the at least one criterion; and
receiving information indicating which of the at least one criterion are satisfied,
wherein the differentiating is based on the received information.

9. The method of claim 1, wherein the at least one criterion includes demographics.

10. The method of claim 1, wherein the differentiating the display of the advertisement comprises displaying the advertisement with a particular banner, frame, background color, font, or additional image when the at least one criterion is satisfied.

11. The method of claim 1, wherein the at least one criterion is user controlled.

12. A method of operating a server, comprising:
receiving at least one criterion;
differentiating a display of an advertisement based on the at least one criterion in order to indicate to a user of a wireless device a satisfaction of the at least one criterion; and
sending the differentiated advertisement for display on the wireless device.

13. The method of claim 12, wherein the at least one criterion is received through peer-to-peer communication.

14. The method of claim 12, wherein the at least one criterion includes at least one of a location associated with the advertisement or a proximity of the wireless device to the location associated with the advertisement.

15. The method of claim 14, further comprising determining the location associated with the advertisement and a location of the wireless device, wherein the at least one criterion includes the proximity of the wireless device to the location associated with the advertisement, and the advertisement is differentiated based on a difference between the determined locations.

16. The method of claim 12, wherein the at least one criterion includes demographics.

17. The method of claim 12, wherein the advertisement is differentiated by a particular banner, frame, background color, font, or additional image in order to indicate to the user of the wireless device the satisfaction of the at least one criterion.

18. An apparatus for wireless communication, comprising:
means for displaying an advertisement on the apparatus; and
means for differentiating the display of the advertisement based on at least one criterion in order to indicate to a user of the apparatus a satisfaction of the at least one criterion.

19. The apparatus of claim 18, wherein the at least one criterion includes at least one of a location associated with the advertisement or a proximity of the apparatus to the location associated with the advertisement.

20. The apparatus of claim 18, wherein the location associated with the advertisement is determined through one of peer-to-peer wireless peer discovery or location information received with the advertisement.

21. The apparatus of claim 20, further comprising:
means for receiving a peer discovery signal; and
means for determining a proximity of the apparatus to the location associated with the advertisement through a power measurement of the received peer discovery signal.

22. The apparatus of claim 20, further comprising:
means for receiving the advertisement;
means for receiving with the advertisement location information embedded with the advertisement; and
means for determining the location associated with the advertisement based on the received location information.

23. The apparatus of claim 22, further comprising:
means for determining a location of the apparatus; and
means for determining the proximity of the apparatus to the location associated with the advertisements based on a difference between the determined locations.

24. The apparatus of claim 18, further comprising:
means for sending the at least one criterion; and
means for receiving the advertisement differentiated based on the at least one criterion,
wherein the means for differentiating displays the differentiated advertisement.

25. The apparatus of claim 18, further comprising:
means for sending the at least one criterion; and
means for receiving information indicating which of the at least one criterion are satisfied,
wherein the differentiating is based on the received information.

26. The apparatus of claim 18, wherein the at least one criterion includes demographics.

27. The apparatus of claim 18, wherein the means for differentiating the display of the advertisement displays the advertisement with a particular banner, frame, background color, font, or additional image when the at least one criterion is satisfied.

28. The apparatus of claim 18, wherein the at least one criterion is user controlled.

29. An apparatus for wireless communication, comprising:
means for receiving at least one criterion;
means for differentiating a display of an advertisement based on the at least one criterion in order to indicate to a user of a second apparatus a satisfaction of the at least one criterion; and
means for sending the differentiated advertisement for display on the second apparatus.

30. The apparatus of claim 29, wherein the at least one criterion is received through peer-to-peer communication.

31. The apparatus of claim 29, wherein the at least one criterion includes at least one of a location associated with the advertisement or a proximity of the second apparatus to the location associated with the advertisement.

32. The apparatus of claim 31, further comprising means for determining the location associated with the advertisement and a location of the second apparatus, wherein the at least one criterion includes the proximity of the second apparatus to the location associated with the advertisement, and the advertisement is differentiated based on a difference between the determined locations.

33. The apparatus of claim 29, wherein the at least one criterion includes demographics.

34. The apparatus of claim 29, wherein the advertisement is differentiated by a particular banner, frame, background color, font, or additional image in order to indicate to the user of the second apparatus the satisfaction of the at least one criterion.

35. A computer program product in a wireless device, comprising:
a computer-readable medium comprising code for:
displaying an advertisement on the wireless device; and
differentiating the display of the advertisement based on at least one criterion in order to indicate to a user of the wireless device a satisfaction of the at least one criterion.

36. A computer program product in a wireless device, comprising:
a computer-readable medium comprising code for:
receiving at least one criterion;
differentiating a display of an advertisement based on the at least one criterion in order to indicate to a user of a wireless device a satisfaction of the at least one criterion; and
sending the differentiated advertisement for display on the wireless device.

37. An apparatus for wireless communication, comprising:
a processing system configured to:
display an advertisement on the apparatus; and
differentiate the display of the advertisement based on at least one criterion in order to indicate to a user of the apparatus a satisfaction of the at least one criterion.

38. An apparatus for wireless communication, comprising:
a processing system configured to:
receive at least one criterion;
differentiate a display of an advertisement based on the at least one criterion in order to indicate to a user of a second apparatus a satisfaction of the at least one criterion; and
send the differentiated advertisement for display on the second apparatus.
